(19) United States
(12) Patent Application Publication
(10) Pub. No.: US 2006/0215406 A1
(43) Pub. Date: Sep. 28, 2006

(54) Medical diagnostic instrument with highly efficient, tunable light emitting diode light source

(76) Inventor: William Thrailkill, Stockbridge, VT (US)

Correspondence Address: CESARI AND MCKENNA, LLP, 88 BLACK FALCON AVENUE, BOSTON, MA, 02210, US

(21) Appl. No.: 11/086,887

(22) Filed: Mar. 22, 2005

Related U.S. Application Data
(60) Provisional application No. 60/654,404, filed on Feb. 18, 2005.

(51) Int. Cl. F21V 21/00; F21S 13/14

(52) U.S. Cl. 362/252; 362/249; 362/804

(57) ABSTRACT

A medical diagnostic instrument, such as a colposcope for examining cervical tissue, includes a light source comprising an annular array of high intensity light emitting diodes (LEDs). The LED array includes a central access opening which provides viewing access for the colposcope optical components to the illumination site. The array includes a plurality of sets of LEDs, with each set including a red, blue and green emitting LED. The intensities of the red, blue and green LEDs, respectively, are controllable with a controller to continuously vary or tune the spectral characteristics of the illumination from the light source. Selected color mixes can be stored in a memory for later retrieval.

### CROSS-REFERENCE TO RELATED APPLICATIONS

The present application claims the benefit of U.S. Provisional Patent Application Serial No. 60/654,404, which was filed on Feb. 18, 2005, by William Thrailkill for a MEDICAL DIAGNOSTIC INSTRUMENT WITH HIGHLY EFFICIENT, TUNABLE LIGHT EMITTING DIODE LIGHT SOURCE and is hereby incorporated by reference.

### FIELD OF THE INVENTION

This invention relates generally to medical diagnostic instruments such as colposcopes used for visually inspecting the cervix for malignancies and other abnormalities. It relates more particularly to instruments of this type having a highly efficient, tunable light emitting diode (LED) light source to provide uniform illumination at broadly selectable wavelengths.

### BACKGROUND INFORMATION

Cancer of the cervix is one of the most common cancers among women. It is also one of the most effectively treatable cancers, provided that it is detected early enough. For several decades now, the standard initial screening procedure for the early detection of cervical cancer and its precursors has been the Pap smear. Abnormal Pap smear samplings are typically followed-up by colposcopy.

Colposcopy involves visually inspecting the cervix of patients who have some prior indication of abnormality. The procedure is conventionally performed using a colposcope. This device includes a binocular microscope together with a bright light source configured to allow close visual examination of cervical tissue. The operator looks through the microscope while the cervix is illuminated with bright light to locate indications of malignancies and other abnormalities. The instrument may also be used to guide biopsy sampling of cervical tissue.

The colposcope inspection process is typically aided by the application of an acetic acid wipe of the cervix. Acetic acid induces transient whitening changes in epithelial tissues. Spatial and temporal changes in this acetowhitening are major visual diagnostic indicators in the procedure and are interpreted by trained colposcopists based upon prior experience with the procedure.

Often the colposcope is equipped with a camera disposed to take either still or video images of the illuminated cervical tissue for archival purposes. These permanent images can also be analyzed for various reflectance and/or fluorescence patterns which enhance the specificity and objectivity of the examination.

The light source is an important part of the colposcope. It must provide illumination at a sufficiently high intensity to permit effective visual inspection of the targeted tissue. The illumination must also be substantially uniform to prevent light intensity variations from being interpreted falsely as tissue variations. In many conventional colposcopes, the light source is a white light source such as a xenon or halogen lamp. Light from the lamp is delivered to an illumination site in the instrument by a fiber optic light carrier. Lenses and other optical components between the lamp and illumination site serve to focus and concentrate the light incident on the target. Other known colposcopes have used light sources ranging from incandescent lamps to lasers to chemoluminescent emitters. Various examples of colposcopes with a variety of light sources are disclosed in the following U.S. Pat. Nos.: 4,905,670; 4,979,498; 5,179,938; 5,421,339, 5,989,184; 6,212,425; 6,277,067 and 6,496,718.

It is generally known that different tissue structures and abnormalities produce different visual, reflective and/or fluorescent patterns in response to different illumination wavelengths. It would be desirable to provide a colposcope or other such lighted medical diagnostic instrument that gives the operator the flexibility to vary its illumination spectrum over a broad range of wavelengths. Conventional colposcopes with white light sources such as xenon or halogen lamps can be equipped with optical filters to achieve wavelength selectability. Such filters add to the cost and complexity of the light source, and typically provide illumination only at discrete wavelengths or spectral ranges.

### SUMMARY OF THE INVENTION

Accordingly, it is an object of the present invention to provide a medical diagnostic instrument such as a colposcope having an improved high intensity light source.

Another object of the invention is to provide an instrument of the type described with a light source that incorporates an array of high-intensity LEDs which combine to produce a uniform light field.

Yet another object of the invention is to provide an instrument of the type described with a light source that incorporates an array of red, green and blue LEDs which combine to produce illumination at any of a broad range of wavelengths.

A further object of the invention is to provide an instrument of the type described with a light source that provides its operator with the flexibility of producing white light illumination or illumination at any desired mix of the elemental red, green and blue wavelengths.

Still another object of the invention is to provide an instrument of the type described with a light source in the form of a circular ring array of LEDs having a central access opening for target viewing or imaging, thus enabling the instrument to have a compact and simple mechanical and optical design.

These and other objects of the invention will be better understood by those skilled in the art from the detailed description of illustrative embodiments of the invention which appears below and the accompanying drawings.

Briefly, a medical diagnostic instrument in accordance with one embodiment of my invention takes the form of a colposcope with a microscope and/or camera for viewing and/or imaging cervical tissue and a light source for illuminating the site to be viewed and/or imaged comprising an array of LEDs. The LEDs are preferably arranged in a circular ring pattern and supported on a thermally conductive base plate. An access opening at the center of the base plate provides viewing and/or imaging access for the microscope and/or camera to the targeted illumination site.

The LEDs in the array are provided as a plurality of sets of red, green and blue emitting LEDs. A controller/driver allows independent control of the illumination intensities of the red, green and blue LEDs, respectively, in the array, from maximum to a minimum. In this way, the spectral characteristics of the combined light output from the array can be continuously varied. An electronic preset memory allows the operator to store and later retrieve selected settings of the controller/driver which provide desired spectral illumination characteristics in the instrument.

In the preferred embodiment of the invention, the LEDs are high intensity LEDs and have heat sinks which are in intimate thermal contact with the base plate. During the mounting process, the LEDs are preferably fitted with secondary lenses which are aimed such that the light beams from the LEDs illuminate corresponding fixed targets which have a predetermined spatial relationship so that the light source produces a very uniform light field. After the secondary lenses are aimed or targeted in this fashion, their positions are permanently fixed in a suitable manner, such as by using a UV-curable adhesive.

Thus, a colposcope or similar lighted medical diagnostic instrument embodied in accordance with my invention provides a high intensity, illumination field with a high degree of uniformity across the chosen target. The ring-like configuration of the light source enables the instrument to have a compact and simple mechanical and optical design. The spectral characteristics of the illumination are continuously tunable over a broad range of wavelengths from white light to light at the wavelengths of the individually-colored LEDs, without the need for costly or complex optical filters. Optimal spectral color mixes can be saved in memory by the operator for later retrieval as needed.

### BRIEF DESCRIPTION OF THE DRAWINGS

For a fuller understanding of the objects, features and advantages of the invention, reference should be made to the following detailed description taken in conjunction with the accompanying drawings, in which:

FIG. 1 is a partially pictorial, partially block diagrammatic illustration of a colposcope embodied according to the invention with an LED ring array light source;

FIG. 2 is a front plan view of the LED ring array light source used in the colposcope of FIG. 1;

FIG. 3 is a sectional view on a larger scale showing a single LED in the ring array mounted to a thermal base plate and fitted with a secondary lens; and

FIG. 4 is a block diagram of a controller/driver for independently controlling the intensities of the red, blue and green LEDs, respectively, and of a preset memory for storing indications of selected settings of the controller.

### DETAILED DESCRIPTION OF AN ILLUSTRATIVE EMBODIMENT

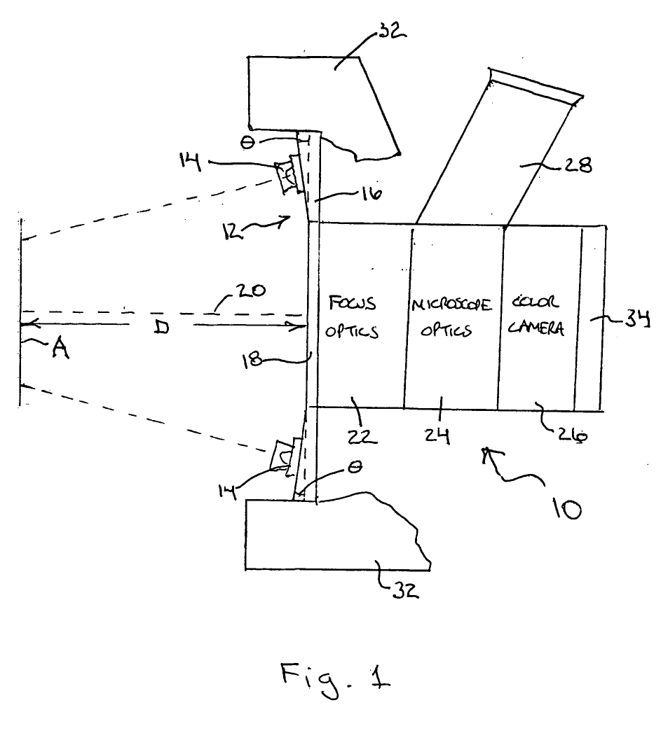

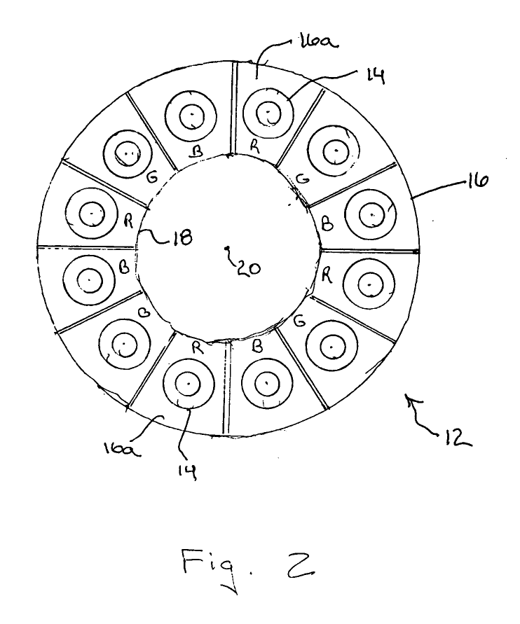

Referring now specifically to FIGS. 1 and 2 of the drawing, there is shown generally a colposcope 10 and associated light source 12 embodied in accordance with my invention. The light source 12 is comprised of a plurality of high intensity LEDs 14 equiangularly spaced around an outwardly-looking face of an annular base plate 16. The base plate 16 includes a central access opening 18 having a central axis 20. Aligned along the central axis in the colposcope 10 are focus optics 22, microscope optics 24 and, optionally, a color camera 26. A target area A, in this particular example, an area of the cervix, is viewable under magnification by an operator via the microscope optics 24 through a binocular viewer 28. The focus optics 22 allow adjustment of the focal plane of the microscope optics 24 and binocular viewer 28 on the target A which is spaced at a predetermined distance D from the light source 12. The camera 26, which is preferably a digital color CCD camera, may provide still pictures of the magnified and focused images of the target A, under the control of the operator. Alternatively, the camera 26 may provide video images of the target A. A housing 32 encases the light source 12, focus optics 22, microscope optics 24 and camera 26, leaving the binocular viewer 28 exposed for access by the operator. A display 34 may be mounted externally of the housing 32. The display 34 is preferably a digital LCD display compatible with the camera 26.

As best seen in FIG. 2, the LEDs 14 in the light source 12 are arranged in multiple sets of three around the face of base plate 16, with each set including a red emitting LED (“R”), a green-emitting LED (“G”) and a blue-emitting LED (“B”). In this particular embodiment, there are four sets of RGB LEDs, one set in each quadrant of the base plate 16, for a total of 12 LEDs 14. The LEDs are preferably high intensity (e.g., 1-5 watt) LEDs such as those available from Lumiled Lighting under the designation LUXEON. The red LEDs emit light narrowly centered around a wavelength of 625 nanometers (“nm”), the green LEDs emit light narrowly centered around a wavelength of 530 nm, while the blue LEDs emit light narrowly centered around a wavelength of 470 nm. The LEDs are driven by applying a drive current to them from a suitable power source (not shown). The emission intensity of each LED can be varied from near zero to a maximum (100%) by varying the drive current.

High intensity LEDs of the type described provide several advantage over other, more conventional light source elements, which makes them particularly well suited for application to medical diagnostic instruments like colposcope 10. They have substantially higher fluxes and luminous densities than standard, low intensity LEDs. They are more energy-efficient than incandescent and most halogen lamps. They have extremely long operating lives, up to 100,000 hours. They serve as a cool light source which is safe to touch. Finally, they are fully dimmable, and provide an essentially instant on capability, which makes them well-suited for strobed applications.

The housing 32 of the colposcope 10 of FIG. 1 can have any desired shape or size which may be usefully employed for disposition relative to the desired target area A, in this particular example, the cervix. The colposcope 10 may be used with or without a speculum or other such instrument, for facilitating viewing access to the cervix. In a specific illustrative embodiment of the colposcope 10, the light source 12 has an outer diameter of 140 millimeters (“mm”). It is designed to uniformly illuminate a target area A of 75 mm spaced at a distance D of 300 mm from the light source center on the central axis 20.

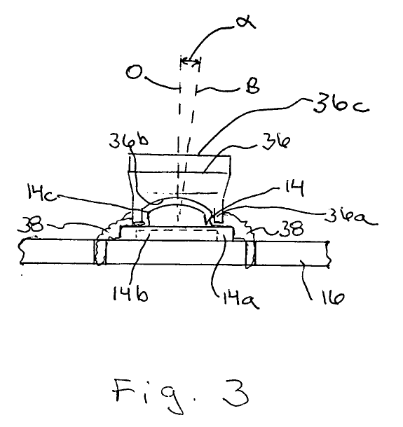

As best seen in FIG. 3, each LED 14 includes a main body portion 14a which extends up from a heat sink slug 14b, and is topped off by a plastic lens 14c. Because the high intensity LEDs draw relatively large currents (i.e., in the range of about 350-750 milliamps per LED), they generate much more heat than lower intensity conventional LEDs. The base plate 16 to which the LEDs 14 are mounted is preferably made of a highly thermally conductive material such as copper. Each LED 14 is mounted (e.g., soldered) in a pocket area 16a of the base plate 16 with its heat sink slug 14b in intimate thermal contact with the base plate 16. The face of the base plate 16 looking into the housing 32 may be provided with a plurality of cooling fins (not shown) to further improve thermal conduction and dissipation.

As best seen in FIG. 1, the LED mounting surface of each of the base plate pocket areas 16a is disposed at a slight angle θ relative to the vertical plane of the base plate 16. This allows the LEDs to be coarsely aimed or targeted at the target A to achieve a desired illumination area at the target A. The angles θ may vary from pocket area to pocket area 16a to achieve a relatively uniform light intensity distribution at the target A. The base plate 16 may be cast or machined from copper with the desired angles θ built into the pocket areas 16a for this coarse aiming or targeting purpose.

Referring back to FIG. 3, it can be seen that the light beam center line B of a given LED 14 may not be symmetrical about the optical axis 0 of the LED due to manufacturing tolerances, and may deviate from the optical axis 0 by an angle α. In the preferred embodiment of my invention, these imperfections in the LEDs 14 are compensated for using the techniques disclosed in my prior U.S. Pat. No. 5,822,053 and my copending patent application Ser. No. 60/602,563 filed on Aug. 18, 2004, both of which disclosures are incorporated herein by reference. Because the LEDs 14 are preferably high intensity LEDs, the technique disclosed in my copending application Ser. No. 60/602,563 is preferred.

According to this technique, each LED 14 is fitted with a secondary lens 36. Each lens 36 includes a collar 36a which may be engaged around or clipped onto the main body 14a of its associated LED 14. Lens 36 has an interior surface 36b spaced somewhat from the lens 14c of the LED 14, and a curvature that generally corresponds to that of lens 14c so that the light emanating from the LED 14 suffers minimal distortion upon passing through the secondary lens 36.

As discussed in my copending application Ser. No. 60/602,563, each secondary lens 36 is adjusted (e.g., tilted) relative to the LED lens 14c to compensate for any asymmetry in its associated LED 14. Applying this technique to all of the LEDs 14 in the light source 12 allows the uniformity of the light distribution at the target A to be finely adjusted. After the LEDs 14 have been properly aimed in this fashion, the secondary lenses 36 can be secured in place with a UV-curable curable adhesive 38.

Each secondary lens 36 may be topped with a light collimator 36c or similar optical element which serves to minimize the spread of light emanating from the lens 36 for even more effective aiming.

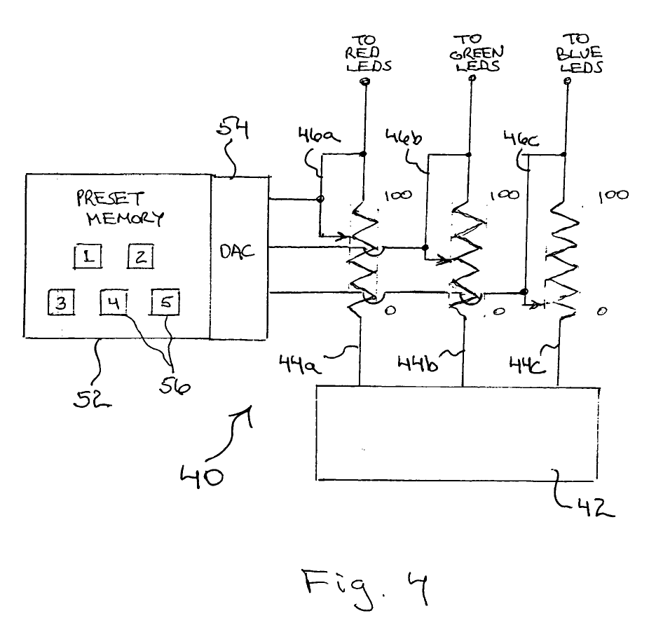

FIG. 4 illustrates one possible implementation of a driver/controller unit 40 for the LEDs 14 of the light source 12. A fixed current power supply 42 supplies constant drive currents to three parallel drive circuits 44a, 44b and 44c. Each drive circuit includes an adjustable current control component such as a potentiometer 46a, 46b and 46c. The drive circuit 44a is connected to and drives all of the red LEDs 14 in the light source 12, the drive circuit 44b is connected to and drives all of the green LEDs 14, and the drive circuit 44c is connected to and drives all of the blue LEDs 14. The potentiometers 46a, 46b and 46c are independently adjustable by an operator of the colposcope 10 to independently control the drive currents supplied to, and thus, the intensities of the light emissions from, the red, green and blue LEDs 14, respectively. In this manner, the operator can continuously adjust the spectral characteristics of the light emanating from the light source 12, from white light illumination, with the red, green and blue LEDs 14 each receiving maximum drive currents, to illumination at one of the elemental wavelengths, say for example, green, with the drive currents to the green LEDs 14 being at a maximum and the drive currents to the red and blue LEDs 14 being at or near zero or a minimum.

A memory unit 52 may advantageously be coupled digitally to the potentiometers 46a, 46b and 46c, such as through a digital-to-analog converter 54. The memory unit 52 includes a preset memory capability, similar to that in automobile radio, for storing digital representations of the settings of the potentiometer 46a, 46b and 46c which produce desired spectral illumination mixes, as determined by the operator. The digital representations of the potentiometer settings are preferably stored in the memory unit 52 and retrieved therefrom using a series of preset buttons 56.

As an alternative, the potentiometers 46a, 46b and 46c could be replaced by or used to control pulse width modulation (PWM) controllers which control the duty cycle of a fixed drive current signal from the power supply 42 to each of the drive circuits 44a, 44b and 44c. The operator of the colposcope 10 uses the potentiometers 46a, 46b and 46c, or other suitable variable control, to independently and continuously vary the duty cycle of the drive signal in each drive circuits 44a, 44b and 44c, which in turn varies the brightness of the LEDs 14 in each drive circuit.

Those skilled in the art will appreciate that there are many other circuits that can be used to perform the functions of the driver/controller 40 and memory unit 52, including microcontrollers, digital signal processors and the like.

It can thus be seen that the objects set forth above, including those made apparent from the preceding description, are efficiently attained with my invention. Those skilled in the art will appreciate that various modifications may be made to the specific embodiments described herein without departing from the scope of the invention. For example, although the above description relates specifically to a colposcope, it will be readily appreciated that my invention can be adapted for use as an endoscopic instrument for illumination and examination of any of several body cavities. Because of its compact and simple mechanical and optical design, the described instrument can be miniaturized for those applications that require that the instrument be inserted into the body cavity for effective diagnostic purposes. It is thus intended that all matter contained in the above description and shown in the accompanying drawings be interpreted as illustrative and not in a limiting sense.

What is claimed is:

1. Apparatus for use in examining a selected region of a body for medical diagnostic purposes, said apparatus comprising:
a housing,
an optical component mounted relative to said housing for enabling viewing of the selected body region along an optical axis,
a light source mounted relative to said housing for illuminating the selected body region,
said light source comprising an annular array of light emitting diodes surrounding an access opening,
said optical component being disposed so that its optical axis passes through the access opening of said array.

2. The apparatus of claim 1 in which said array includes an annular base plate which defines the access opening and in which said light emitting diodes are mounted to said base plate.

3. The apparatus of claim 2 in which said base plate is formed of a thermally conductive material and in which said light emitting diodes are mounted in thermal contact with said base plate.

4. The apparatus of claim 3 in which said base plate is formed of copper.

5. The apparatus of claim 1 in which the access opening of said array is substantially circular with a central axis and in which the optical axis of said optical component is coincident with the central axis of the access opening.

6. The apparatus of claim 1 in which said light emitting diodes are equiangularly spaced about said array.

7. The apparatus of claim 1 in which said light emitting diodes are high intensity light emitting diodes of at least one watt power.

8. The apparatus of claim 1 in which said optical component includes magnifying optics that produces a magnified image of the selected body region during viewing with the apparatus.

9. The apparatus of claim 1 in which said optical component includes focusing optics that produces a focused image of the selected body region during viewing with the apparatus.

10. The apparatus of claim 1 further including a binocular viewer mounted relative to said housing and optically coupled to said optical component for enabling viewing of the selected body region by an operator of the apparatus.

11. The apparatus of claim 1 further including a camera mounted relative to said housing and optically coupled to said optical component for generating an image of the selected body region being viewed.

12. The apparatus of claim 11 in which said camera is a still camera for generating a still image of the selected body region being viewed.

13. The apparatus of claim 11 in which said camera is a video camera for generating a video image of the selected body region being viewed.

14. The apparatus of claim 11 further including a controller for controlling the intensities of the light emitting diodes in said array.

15. The apparatus of claim 1 in which said array comprises a plurality of sets of light emitting diodes, each of said sets including a red-emitting light emitting diode, a green-emitting light emitting diode and a blue-emitting light emitting diode.

16. The apparatus of claim 15 further including a controller for controlling the intensities of said red, blue and green-emitting light emitting diodes, respectively, in said sets.

17. The apparatus of claim 16 further including a memory operatively coupled to said controller for storing representations of selected intensities of said red, blue and green-emitting light emitting diodes, respectively, corresponding to illumination from said light source of desired spectral characteristics.

18. The apparatus of claim 17 further including means for selectively retrieving said intensity representations from said memory for input to said controller.

19. The apparatus of claim 1 in which each of said light emitting diodes is aimed so as to illuminate a predetermined sector in a predetermined lighting pattern at a predetermined distance from said array to compensate for optical imperfections in said light emitting diodes and to produce a substantially uniform field of illumination at said distance.

20. The apparatus of claim 1 in which each of said light emitting diodes includes a primary lens and a secondary lens that is adjustable relative to said primary lens so as to illuminate a predetermined sector in a predetermined lighting pattern at a predetermined distance from said array to compensate for optical imperfections in said light emitting diodes and to produce a substantially uniform field of illumination at said distance.

21. The apparatus of claim 1 in which said housing, said optical component and said light source are adapted for use as a colposcope for examining cervical tissue.

22. Apparatus for use in examining a selected region of a body for medical diagnostic purposes, said apparatus comprising:
a housing,
an optical component mounted relative to said housing for enabling viewing of the selected body region,
a light source mounted relative to said housing for illuminating the selected body region,
said light source comprising a plurality of sets of red, blue and green light emitting diodes, and
a controller for controlling the intensities of said red, blue and green light emitting diodes, respectively, in said sets to vary the spectral characteristics of the illumination from said light source.

23. The apparatus of claim 22 in which said controller includes means for independently varying the intensities of said red, blue and green light emitting diodes, respectively, to vary the spectral characteristics of the illumination from said light source.

24. The apparatus of claim 23 further including a memory operatively coupled to said controller for storing representations of selected intensities of said red, blue and green light emitting diodes, respectively, corresponding to illuminations from said light source of desired spectral characteristics.

25. The apparatus of claim 22 further including means for selectively retrieving said intensity representations from said memory for input to said controller.

26. The apparatus of claim 22 in which said light source includes an annular base plate which defines an access opening and in which said light emitting diodes are mounted to said base plate.

27. The apparatus of claim 26 in which said base plate is formed of a thermally conductive material and in which said light emitting diodes are mounted in thermal contact with said base plate.

28. The apparatus of claim 27 in which said base plate is formed of copper.

29. The apparatus of claim 26 in which the access opening in said base plate is substantially circular with a central axis and in which the optical axis of said optical component is coincident with the central axis of the access opening.

30. The apparatus of claim 26 in which said light emitting diodes are equiangularly spaced about said array.

31. The apparatus of claim 22 in which said light emitting diodes are high intensity light emitting diodes of at least one watt power.

32. The apparatus of claim 22 in which said optical component includes magnifying optics that produces a magnified image of the selected body region during viewing with the apparatus.

33. The apparatus of claim 22 in which said optical component includes focusing optics that produces a focused image of the selected body region during viewing with the apparatus.

34. The apparatus of claim 22 further including a binocular viewer mounted relative to said housing and optically coupled to said optical component for enabling viewing of the selected body region by an operator of the apparatus.

35. The apparatus of claim 22 further including a camera mounted relative to said housing and optically coupled to said optical component for generating an image of the selected body region being viewed.

36. The apparatus of claim 35 in which said camera is a still camera for generating a still image of the selected body region being viewed.

37. The apparatus of claim 35 in which said camera is a video camera for generating a video image of the selected body region being viewed.

38. The apparatus of claim 22 in which each of said light emitting diodes is aimed so as to illuminate a predetermined sector in a predetermined lighting pattern at a predetermined distance from said light source to compensate for optical imperfections in said light emitting diodes and to produce a substantially uniform field of illumination at said distance.

39. The apparatus of claim 22 in which each of said light emitting diodes includes a primary lens and a secondary lens that is adjustable relative to said primary lens so as to illuminate a predetermined sector in a predetermined lighting pattern at a predetermined distance from said light source to compensate for optical imperfections in said light emitting diodes and to produce a substantially uniform field of illumination at said distance.

40. The apparatus of claim 22 in which said housing, said optical component, said light source and said controller are adapted for use as a colposcope for examining cervical tissue.
